(19) United States
(12) Patent Application Publication
(10) Pub. No.: US 2008/0022119 A1
(43) Pub. Date: Jan. 24, 2008

(54) Method and apparatus for preventing illegal access in electronic device

(75) Inventors: Woo-Gyu Lim, Seoul (KR); Jae-Min Jung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/803,644

(22) Filed: May 15, 2007

(30) Foreign Application Priority Data
Jul. 20, 2006 (KR) 2006-0067732

(51) Int. Cl. H04K 1/00

(52) U.S. Cl. 713/183

(57) ABSTRACT

An apparatus and a method for preventing illegal access of a system in an electronic device are provided. The method includes when an event for accessing a system occurs, requesting a visitor to input a password; determining whether a prohibition key, set in advance, is contained in the password input by the visitor; and prohibiting the visitor from accessing the system when the prohibition key is contained in the password.

### PRIORITY

This application claims priority under 35 U.S.C. §119(a) to a Korean Patent Application filed in the Korean Intellectual Property Office on Jul. 20, 2006 and assigned Serial No. 2006-67732, the contents of which are incorporated herein by reference.

### BACKGROUND OF THE INVENTION

1. Field of the Invention

The present invention relates generally to an apparatus and a method for preventing illegal access of a system in an electronic device, and in particular, to an apparatus and a method for preventing illegal access of a system in an electronic device by detecting a prevention key input to operate a system protection program.

2. Description of the Related Art

As the development of electronic devices continues to increase, there has also been increased interest in developing newer methods for protecting personal and asset data stored and managed within these electronic devices. In one conventional method of protection, users are allowed to set their own password and are, thus, able to access the device's system when the set password is accurately entered in.

As such, this method for accessing a device or system using a password typically requires users to manually enter their password which in turn leaves the password exposed to other users of the device, or to non-users who are within close proximity thereof. Hence, the current password input method for preventing a device password from being exposed has not been shown to provide an adequate defense against an unauthorized user who tries to wrongfully acquire the password.

Therefore, there is needed a method for detecting when an unauthorized user of a device is attempting to secure the device password, prohibiting any access to the device upon detection, and informing the other users of the device that illegal access to the device has been tried.

### SUMMARY OF THE INVENTION

An aspect of the present invention is to substantially solve at least the above problems and/or disadvantages and to provide at least the advantages below. Accordingly, one aspect of the present invention is to provide a method and an apparatus for preventing illegal access of a system in an electronic device.

Another aspect of the present invention is to provide a method and an apparatus for protecting a system in an electronic device by detecting illegal access of the system by an unauthorized user through use of a prevention key in the electronic device.

According to one aspect of the present invention, there is provided a method for preventing illegal access of a system in an electronic device. The method includes when an event for accessing a system occurs, requesting a visitor to input a password; judging whether a prohibition key set in advance is contained in the password input by the visitor; and when the prohibition key is contained in the password, prohibiting the visitor from accessing the system.

According to another aspect of the present invention, there is provided an apparatus for preventing illegal access of a system in an electronic device. The apparatus includes a password checking unit for judging whether a prohibition key set in advance is contained in a password input by a visitor when an event for accessing a system occurs; and a control unit for prohibiting the visitor from accessing to a system and operating a system protection program when the prohibition key is contained in the password.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a circuit structure of an electronic device according to the present invention;

FIG. 2 is a flow diagram illustrating a process for preventing illegal access of a system using a prohibition key in an electronic device according to the present invention;

FIG. 3 is a flow diagram illustrating a process for preventing illegal access of a system through a password input method using a prohibition key and time data in an electronic device according to the present invention; and

FIG. 4 is a flow diagram illustrating a process for preventing illegal access of a system through a password input method using a prohibition key and random number generation in an electronic device according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A method and an apparatus for detecting illegal access of a system by an unauthorized user using a prohibition key in an electronic device to operate a system protection program, and preventing the unauthorized user from accessing the system will be described below.

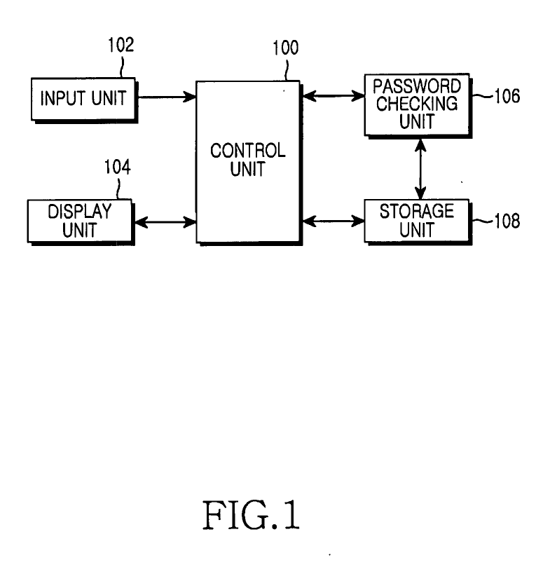

FIG. 1 is a block diagram illustrating a circuit structure of an electronic device according to the present invention. Here, the electronic device includes a control unit 100, an input unit 102, a display unit 104, a password checking unit 106, and a storage unit 108.

In FIG. 1, the control unit 100 controls and processes operations of the electronic device on the whole, and particularly, receives a prohibition key from the input unit 102, and outputs the same to the storage unit 108 when a prohibition key setting event occurs. Likewise, when a user authentication event for accessing a system occurs, the control unit 100 displays a message requesting inputting of a password on the display unit 104, and outputs the password received from the input unit 102 to the password checking unit 106. When a password coincidence signal is received from the password checking unit 106, the control unit 100 allows a visitor to access the system. On the other hand, when a password non-coincidence signal is received, the control unit 100 informs the visitor that the received password is false and prohibits the visitor from accessing the system. Moreover, when a signal informing that a prohibition key is contained in the received password is received from the password checking unit 106, the control unit 100 controls a function for operating a system protection program for preventing the visitor from accessing the system.

The input unit 102 includes a plurality of function keys to provide data corresponding to the key pressed by the visitor to the control unit 100. Particularly, the input unit 102 receives the prohibition key and the password, and provides them to the control unit 100.

The display unit 104 displays status data generated during an operation of a portable terminal, and a limited number of characters. Particularly, the display unit 104 displays a message requesting a visitor to input a password under control of the control unit 100, and displays a message informing the visitor that the password input by the visitor is false.

When a password is input by the visitor, the password checking unit 106 reads a password of a user set in advance from the storing unit 108, and checks whether the input password coincides with the password set in advance. When the input password coincides with the password set in advance, the password checking unit 106 outputs a password coincidence signal to the control unit 100. On the other hand, when the input password does not coincide with the password set in advance, the password checking unit 106 checks whether a prohibition key set in advance is contained in the input password. When the prohibition key set is not contained in the input password, the password checking unit 106 outputs a password non-coincidence signal to the control unit 100. Conversely, when the prohibition key set is contained in the input password, the password checking unit 106 outputs a prohibition key existence signal to the control unit 100.

The storage unit 108 may include a Read Only Memory (ROM), a Random Access Memory (RAM), and a flash ROM. The ROM stores micro codes of a program for processing and controlling at the control unit 100, and a variety of reference data. Particularly, the ROM stores a system protection program for preventing a visitor from accessing to the system in the case where the prohibition key is contained in the input password. The RAM serves as a working memory of the control unit 100 and stores temporary data generated while various programs are executed. The flash ROM stores various updatable data to be stored. Particularly, the flash ROM stores the prohibition key and the password set by a user.

Though the password checking unit 106 of the electronic device judges whether the prohibition key is contained in the password input by the visitor to prevent the illegal access in the above description, the security of the system can be improved further by jointly using the prohibition key and other password input method. For example, the security of the system can be improved by jointly using the prohibition key and methods for input a dynamically changing password such as a password using time data and a password using random number generation.

Here, the password, in using the time data, is a password dynamically changes depending on time generated by inserting a predetermined time factor (e.g., an hour and a minute) of a current time into a password set in advance. For example, in the case where the password set in advance is ‘1234’, the predetermined time factor is a ‘minute’, and the insertion position is ‘1’, and when a current time is 12: 45, then ‘45’ is inserted into the password so that a password of ‘145234’ can be generated.

Moreover, according to the password using the random number generation perform, an operation is performed on the password set in advance and a random number generated by the electronic device using a predetermined operator to generate a dynamically changing password depending on the generated random number. For example, in the case where the password set in advance is ‘1234’, the generated random number is ‘2345’, and the operator is ‘+’, then ‘2345’ is added to ‘1234’, so that a password of ‘3579’ can be generated.

However, a prohibition key can be contained in the two generated dynamically changing password. Therefore, not only whether a prohibition key is simply contained in the dynamically generated password is judged, but also an additional processing procedure should be performed to judge whether the prohibition key is contained. For example, in the case where the password input method using the time data is used, the prohibition key is allowed to exist only in a position in which the time factor is inserted. On the other hand, in the case where the password input method using the random number generation is used, it is possible to get the prohibition key not to be generated by additionally performing a simple operation on the generated password. Here, the operation of generating the dynamically changing password using the time data and the random number generation, and the operation of judging whether the prohibition key is contained in the generated password can be performed by the password checking unit 106 of the electronic device.

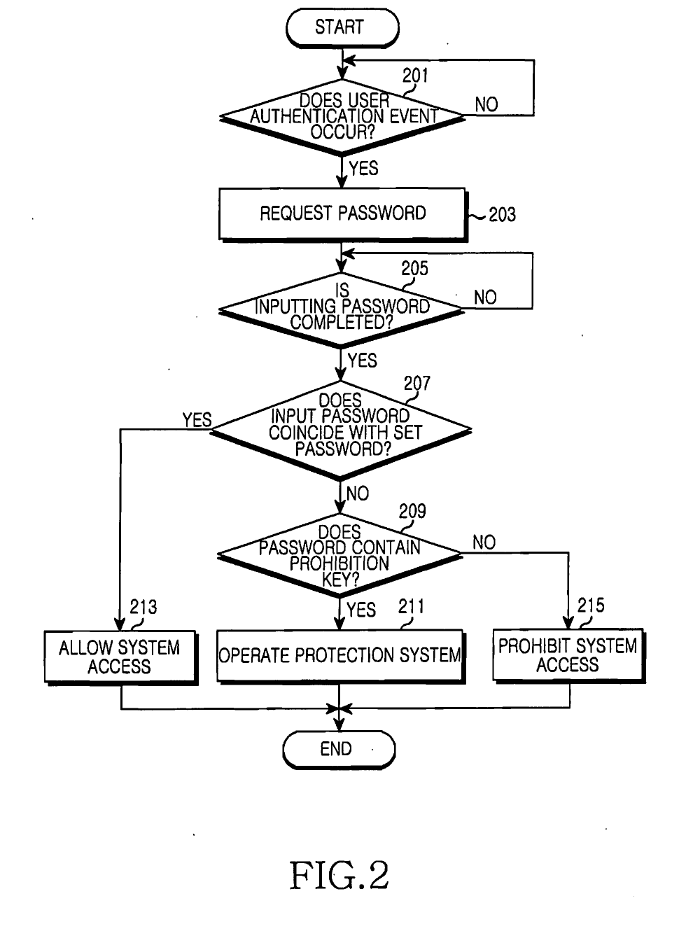

FIG. 2 is a flow diagram illustrating a process for preventing illegal access of a system using a prohibition key in an electronic device according to the present invention.

In FIG. 2, the electronic device checks whether a user authentication event for accessing a system occurs in step 201. When the user authentication event occurs in step 201, the electronic device requests a visitor to input a password in step 203. For example, the electronic device can display a message requesting inputting of a password on the display unit 104, and request inputting of a password through a speaker. The electronic device then examines whether the input of the password is completed by the visitor in step 205. When the input of the password is completed by the visitor in step 205, the electronic device compares the input password with a password set in advance by a user to judge whether they coincide with each other in step 207.

When they coincide with each other in step 207, the electronic device performs step 213 to allow the visitor who has input the password to access a system and ends the process. On the other hand, when they do not coincide with each other in step 207, the electronic device examines whether the input password contains a prohibition key set in advance by the user in step 209.

When the input password does not contain the prohibition key set in advance by the user in step 209, the electronic device judges the input password as a simple input error, performs step 215 to inform that user authentication has failed due to non-coincidence of the password and the authority for accessing to the system is not allowed to the visitor, and prohibits the visitor from accessing the system. The electronic device then ends the process. Here, the electronic device may not end the process and request the visitor to input another password.

Conversely, when the input password contains the prohibition key set in advance by the user in step 209, the electronic device judges the input password as an illegal access and performs step 211 to operate a system protection program for preventing the visitor who has input the password from accessing to the system. For example, assuming that the password set in advance at the electronic device is ‘1234’, the prohibition key is ‘5’, and a password of ‘1235’ is input by a visitor, the electronic device can operate the system protection program for preventing an authorized user from accessing the system because the input password contains the prohibition key of ‘5’. Here, the system protection program perform not only a simple function of prohibiting the visitor from accessing to the system, but also can perform a function of informing the visitor that system delay or system failure has occurred instead of informing the visitor that authority for accessing the system is not allowed to buy a time for which the visitor stays in front of the electronic device, and transmitting an emergence call signal informing a security related organization or system set in advance that an illegal access has been tried. The electronic device then ends the process.

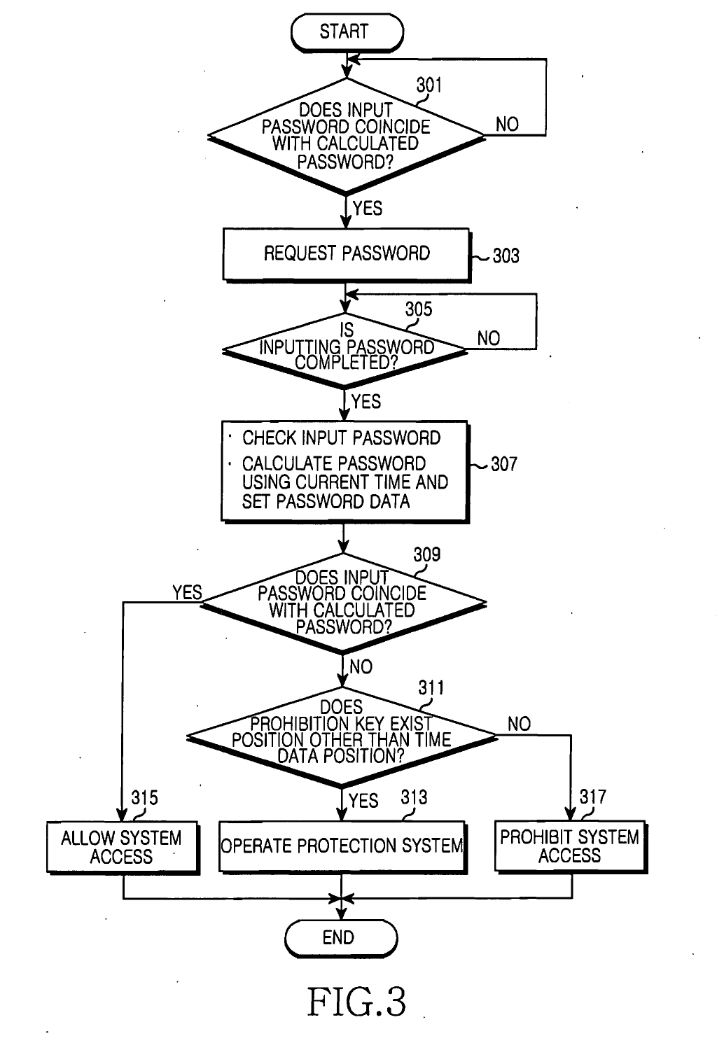

FIG. 3 is a flow diagram illustrating a process for preventing illegal access of a system through a password input method using a prohibition key and time data in an electronic device according to the present invention.

In FIG. 3, the electronic device examines whether a user authentication event for accessing the system occurs in step 301. When the user authentication event for accessing the system occurs in step 301, the electronic device requests a visitor to input a password in step 303.

The electronic device then examines whether the input of the password is completed by the visitor in step 305. When the input of the password is completed by the visitor in step 305, the electronic device checks the input password in step 307, and checks data (e.g., a password set in advance, a current time, and an insertion position set in advance) required for generating a dynamic password using time data to calculate a password for a current time. For example, in the case where conditions of password: 1234, current time: 1:25, time factor: minute, and insertion position: 3 are set at the electronic device, ‘25’, which is a minute component of the current time is inserted into the password of ‘1234’, so that a password of ‘123254’ is calculated.

The electronic device then performs step 309 to compare the input password with the calculated password and judge they coincide with each other. When the input password coincides with the calculated password, the electronic device performs step 315 to allow the visitor to access the system and ends the process.

However, when the input password does not coincide with the calculated password, the electronic device examines whether the input password contains a prohibition key set in advance by a user in step 311. At this point, when the input password contains the prohibition at a position where the time factor is inserted in step 311, it is not judged that the prohibition key exists. In other words, whether the prohibition key exists is not judged for the position in which the time factor is inserted. For example, assuming that a prohibition key is ‘5’, and the position in which the time factor is inserted is ‘3’, and when an input password is ‘152346’, it is judged that the input password contains the prohibition key. Conversely, when the input password is ‘123254’, it is judged that the input password does not contain the prohibition key because ‘5’ is included as a time factor in the password though ‘5’ is contained in the calculated password.

When the input password does not contain the prohibition key set in advance in step 311, the electronic device judges the input password as a simple input error, performs step 317 to inform that user authentication has failed due to non-coincidence of the password and the authority for accessing to the system is not allowed to the visitor, and prohibits the visitor from accessing the system. The electronic device then ends the process. Here, the electronic device may not end the process and request the visitor to input another password.

On the other hand, when the input password contains the prohibition key set in advance in step 311, the electronic device judges the input password as an illegal access and performs step 313 to operate a system protection program for preventing the visitor who has input the password from accessing to the system. Thereafter, the electronic device ends the process.

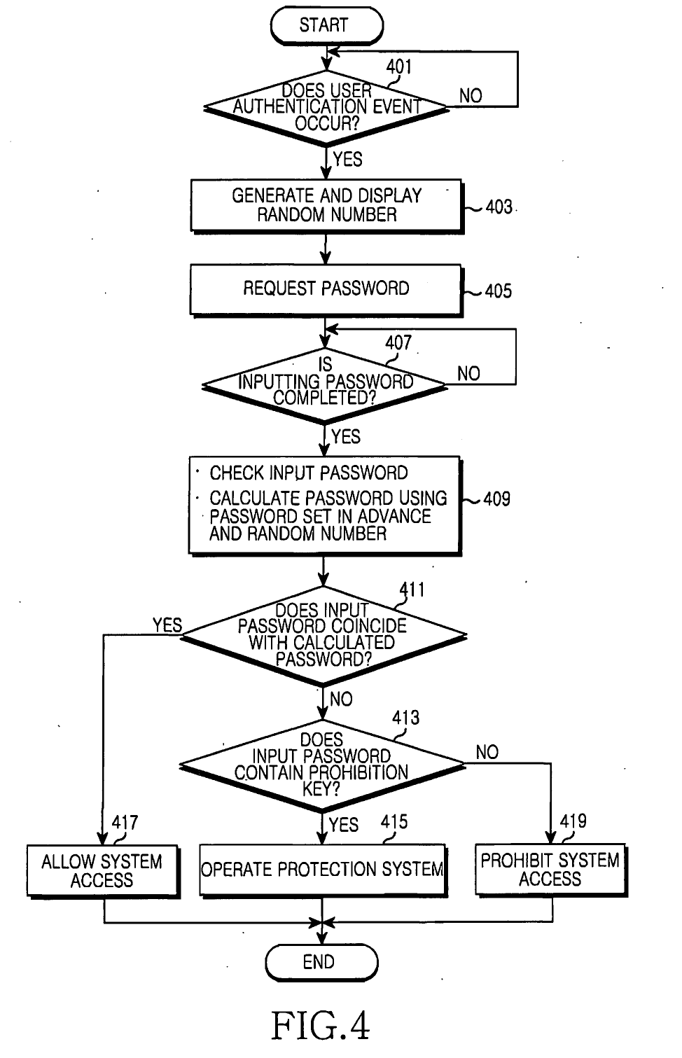

FIG. 4 is a flow diagram illustrating a process for preventing illegal access of a system through a password input method using a prohibition key and random number generation in an electronic device according to the present invention.

In FIG. 4, the electronic device examines whether a user authentication event for accessing a system occurs in step 401. In operation, when the user authentication event for accessing a system occurs in step 401, the electronic device generates a random number and an operator in step 403 and displays them on the display unit 104, and performs step 405 to request a visitor to input a password. Here, since a prohibition key set in advance can be generated when the visitor calculates the password using the random number and the operator, a simple operation for removing the generated prohibition key is additionally performed when the calculated password contains the prohibition key, and the visitor can be requested to input a password obtained by performing the additional operation on the calculated password. For example, when the calculated password contains the prohibition key, the visitor can be requested to add 1 to the prohibition key and input the obtained password.

Next, the electronic device examines whether the input of the password is completed by the visitor in step 407. When the input of the password is completed by the visitor in step 407, the electronic device checks the input password in step 409, and checks data (e.g., a password set in advance, a generated random number, an operator, and an addition operation) required for generating a dynamic password using random number generation to calculate a password for the generated random number. For example, in the case where conditions of password: 1234, generated random number: 2345, operator: +, additional operation: +1, and prohibition key: 7 are set at the electronic device, the generated random number of ‘2345’ is added to the password of ‘1234’, so that a password of ‘3579’ is calculated. Also, since the calculated password of ‘3579’ contains the prohibition key of ‘7’, ‘1’ is added to ‘7’ through the addition operation to obtain a password of ‘3589’.

The electronic device then performs step 411 to compare the input password with the calculated password and judges whether they coincide with each other. When they coincide with each other in step 411, the electronic device performs step 417 to allow the visitor who has input the password to access the system and ends the process.

However, when input password and calculated password do not coincide with each other in step 411, the electronic device examines whether the input password contains a prohibition key set in advance by a user in step 413. When the input password does not contain the prohibition key in step 413, the electronic device judges the input password as a simple input error, performs step 419 to inform that user authentication has failed due to non-coincidence of the password and the authority for accessing to the system is not allowed to the visitor, and prohibits the visitor from accessing the system. The electronic device then ends the process. Here, the electronic device may not end the process and request the visitor to input another password.

When the input password contains the prohibition key in step 413, the electronic device judges the input password as an illegal access and performs step 415 to operate a system protection program for preventing the visitor who has input the password from accessing to the system. Thereafter, the electronic device ends the process.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As described above, when the prohibition key set by the user for preventing an illegal access is input, the electronic device judges the input prohibition key as an illegal access, rather than a simple password input error and operates a system protection program to prevent an unauthorized user from accessing to the system illegally. In addition, in the case where the user is in a alert setting and cannot help telling a visitor a password, the user can operate a system protection program to prohibit the visitor from accessing the system and simultaneously inform other users that the user is in the alert setting by disclosing the password containing the prohibition key to the visitor.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for preventing illegal access of a system in an electronic device, the method comprising:
when an event for accessing a system occurs, requesting a visitor to input a password;
determining whether a prohibition key set in advance is contained in the password input by the visitor; and
when the prohibition key is contained in the password, prohibiting the visitor from accessing the system.

2. The method of claim 1, further comprising: when the prohibition key is contained in the password, operating a program for protecting the system.

3. The method of claim 2, wherein the program for protecting the system transmits an emergency call signal to one user and a system set in advance.

4. The method of claim 1, wherein determining whether the prohibition key set in advance is contained comprises:
comparing the input password with a password set in advance to determine whether they coincide with each other; and
when they do not coincide with each other, judging whether the input password contains the prohibition key.

5. The method of claim 4, further comprising: when the input password does not contain the prohibition key, informing that authority for accessing the system is not allowed due to non-coincidence of the input password.

6. The method of claim 1, wherein determining whether the prohibition key set in advance is contained comprises:
checking a time factor set in advance to calculate a dynamically changing password depending on time;
determining whether the password input by the visitor coincides with the calculated password; and
when the password input by the visitor does not coincide with the calculated password, determining whether the input password contains the prohibition key at a position other than a position in which the time factor is inserted.

7. The method of claim 1, wherein determining whether the prohibition key set in advance is contained comprises:
calculating a dynamically changing password using a password set in advance, a random number generated upon request of the password, and an operator;
when the calculated password contains the prohibition key, performing an additional operation for removing the prohibition key on the calculated password;
determining whether the password input by the visitor coincides with the additionally operated password; and
when the password input by the visitor does not coincide with the additionally operated password, determining whether the input password contains the prohibition key.

8. An apparatus for preventing illegal access of a system in an electronic device, the apparatus comprising:
a password checking unit for determining whether a prohibition key set in advance is contained in a password input by a visitor when an event for accessing a system occurs; and
a control unit for prohibiting the visitor from accessing to a system and operating a system protection program when the prohibition key is contained in the password.

9. The apparatus of claim 8, wherein the password checking unit determines whether the input password coincides with a password set in advance, and determines whether the input password contains the prohibition key when the input password does not coincide with the password set in advance.

10. The apparatus of claim 8, wherein the password checking unit calculates a dynamically changing password depending on time to determines whether the calculated password coincides with the input password, and determines whether the input password contains the prohibition key at a position other than a position in which the time factor is inserted when the calculated password does not coincide with the input password.

11. The apparatus of claim 8, wherein the password checking unit calculates a dynamically changing password using a random number, performs an additional operation for removing the prohibition key on the calculated password when the calculated password contains the prohibition key, and determines whether the input password contains the prohibition key when the input password does not coincide with the additionally operated password.

12. An electronic device for preventing illegal access of a system, comprising:
a password checking unit for determining whether a prohibition key set is contained in a password input by a visitor; and
a control unit for prohibiting the visitor from accessing to a system and operating a system protection program when the prohibition key is contained in the password.

13. The electronic device of claim 12, wherein the password checking unit determines whether the input password coincides with a password set in advance, and determines whether the input password contains the prohibition key when the input password does not coincide with the password set in advance.

14. The electronic device of claim 12, wherein the password checking unit calculates a dynamically changing password depending on time to determines whether the calculated password coincides with the input password, and determines whether the input password contains the prohibition key at a position other than a position in which the time factor is inserted when the calculated password does not coincide with the input password.

15. The electronic device of claim 12, wherein the password checking unit calculates a dynamically changing password using a random number, performs an additional operation for removing the prohibition key on the calculated password when the calculated password contains the prohibition key, and determines whether the input password contains the prohibition key when the input password does not coincide with the additionally operated password.

16. A computer-readable recording medium having recorded thereon a program for preventing illegal access of a system in an electronic device, comprising:
a first code segment, for when an event for accessing a system occurs, requesting a visitor to input a password;
a second code segment, for determining whether a prohibition key set in advance is contained in the password input by the visitor; and
a third code segment, for when the prohibition key is contained in the password, prohibiting the visitor from accessing the system.
